(19) United States
(12) Patent Application Publication
(10) Pub. No.: US 2015/0037510 A1
(43) Pub. Date: Feb. 5, 2015

(54) METHOD OF MANUFACTURING A RETARDATION FILM

(71) Applicant: FAR EASTERN NEW CENTURY CORPORATION, Taipei (TW)

(72) Inventors: Wei-Che HUNG, Taoyuan County (TW); Da-Ren CHIOU, Taoyuan County (TW); Yu-June WU, Taoyuan County (TW)

(73) Assignee: FAR EASTERN NEW CENTURY CORPORATION, Taipei (TW)

(21) Appl. No.: 14/205,363

(22) Filed: Mar. 11, 2014

(30) Foreign Application Priority Data
Aug. 1, 2013 (TW) 102127634

(51) Int. Cl. G02F 1/13363

(52) U.S. Cl. CPC G02F 1/13363
USPC 427/520; 427/553; 427/508

(57) ABSTRACT

The present disclosure relates to a method of manufacturing the retardation film. The method includes providing a microstructure substrate. The microstructure substrate has a plurality of protruding portions and a plurality of recessed portions alternatively arranged. The method further includes forming an optical alignment layer on the microstructure substrate. The method further includes applying a polarized ultraviolet (UV) to the optical alignment layer above the microstructure substrate. The polarized UV is applied in a diffusion angle from normal vector of the microstructure substrate such that the optical alignment layer forms a uniform alignment angle, and the diffusion angle is substantially 20°-60°.

This application claims priority to Taiwanese Application Serial Number 102127634, filed Aug. 1, 2013, which is herein incorporated by reference.

### BACKGROUND

1. Field of Invention

The present invention relates to a method of manufacturing a film. More particularly, the present invention relates to a method of manufacturing a retardation film.

2. Description of Related Art

Three-dimensional (3D) image display has become one of the popular subjects among display technology in recent years. Base on visual characteristics of human eyes, when left eye and right eye respectively receive two lights with optical path difference from the same image, 3D visual effect of the image is sensed by human eyes. Therefore, manufacturing a retardation film, which is capable to produce lights with optical path difference, has become a focus of display industry.

Several methods of manufacturing the retardation film have been disclosed as repeated rubbing method (U.S. Pat. No. 6,222,672), LCD ISO phase production method (U.S. Pat. No. 5,926,241), and mechanical processing method (Japan patent 2001-100150), etc. Repeated rubbing method includes applying a mask which covers an optical alignment layer. The mask is then patterned to expose a part of the optical alignment layer. The part of the optical alignment layer is rubbed to form an alignment angle. Sequentially, the other mask is applied, patterned to expose the other part of the optical alignment layer. The other part of the optical alignment layer is then rubbed to form the other alignment angle. Therefore, two different parts of the optical alignment layer with different alignment angles are capable to produce optical path difference for transmittance light therein. However, it is unfavorable for mass production since manufacturing process of repeated rubbing method is complicated. LCD ISO phase production method includes coating a liquid crystal layer on a substrate. The liquid crystal layer is heated to an ISO phase, which has no phase difference, and then a mask is applied to cure and fix a part of the liquid crystal layer in the ISO phase by UV light. Sequentially, the liquid crystal layer is cooled down to a different phase, and the other mask is applied to cure and fix the other part of the liquid crystal layer in the different phase by UV light. Therefore, two different parts of the liquid crystal layer with different alignment angles are also capable to produce optical path difference for transmittance light therein. However, liquid crystal molecules at boundaries of two different parts of liquid crystal layer tend to be randomly aligned and the issue of light leakage is induced so as decreasing display quality mechanical processing method includes attaching a conventional retardation film on a substrate. A part of the conventional retardation film is scratched by a cutter. Therefore, two different parts of the conventional are also capable to produce optical path difference for transmittance light therein. However, the cutter would be deformed during the scratching process, and the yield of manufacturing the retardation film is accordingly reduced.

In this regard, a simple, mass production favored, and high display quality possessed method of manufacturing the retardation film is still a focus of display industry. Accordingly, improvements in methods of manufacturing thereof continue to be sought.

### SUMMARY

The present disclosure provides a method of manufacturing the retardation film. The method of manufacturing the retardation film is simple, mass production favored, and high display quality possessed.

The present disclosure relates to a method of manufacturing the retardation film. The method includes providing a microstructure substrate. The microstructure substrate has a plurality of protruding portions and a plurality of recessed portions alternatively arranged. The method further includes forming an optical alignment layer on the microstructure substrate. The method further includes applying a polarized ultraviolet (UV) to the optical alignment layer above the microstructure substrate. The polarized UV is applied in a diffusion angle from normal vector of the microstructure substrate such that the optical alignment layer forms a uniform alignment angle, and the diffusion angle is substantially 20°-60°.

In various embodiments of the present disclosure, the polarized UV is applied by combining an UV surface light source with a concave lens or a diffuser plate.

In various embodiments of the present disclosure, the operation of forming the optical alignment layer on the microstructure substrate is performed by spin coating, wire bar coating, dip coating, slit coating, or roll-to roll coating a photo orientation resin on the microstructure substrate.

In various embodiments of the present disclosure, the photo orientation resin comprises a photo-induced cross-linking photo orientation resin, a photo-isomerization photo orientation resin, a photo-decomposition photo orientation resin, or combinations thereof.

In various embodiments of the present disclosure, the photo-induced cross-linking photo orientation resin comprises cinnamate, coumarin, chalcone, maleimide, quinoline, bis(benzylidene), or combinations thereof.

In various embodiments of the present disclosure, the operation of applying the polarized UV to the optical alignment layer above the microstructure substrate is performed in a radiation dose substantially 5-180mJ/cm².

In various embodiments of the present disclosure, an altitude difference between the protruding portions and the recessed portions is substantially 1-3 μm.

In various embodiments of the present disclosure, a ratio of a width of the protruding portion and the altitude difference is substantially 60-600.

In various embodiments of the present disclosure, the method further includes forming a liquid crystal layer on the optical alignment layer.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a top-view of a portion of a retardation film 100 in an intermediate stage of manufacture according to various embodiments of the present disclosure;

FIG. 2 is a cross-sectional view of line 2 illustrated in FIG. 1;

FIG. 3 is a cross-sectional view of the portion of the retardation film 100 in an intermediate stage of manufacture according to various embodiments of the present disclosure;

FIG. 4 is a cross-sectional view of the portion of the retardation film 100 in an intermediate stage of manufacture according to various embodiments of the present disclosure;

FIG. 5 is a top-view of the retardation film 100 after being applied to a polarized UV;

FIG. 6 is a cross-sectional view of the portion of the retardation film 100 in an intermediate stage of manufacture according to various embodiments of the present disclosure; and

FIG. 7 is the collection of display images of comparative examples 1-2 and examples 1-4 of the retardation films.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

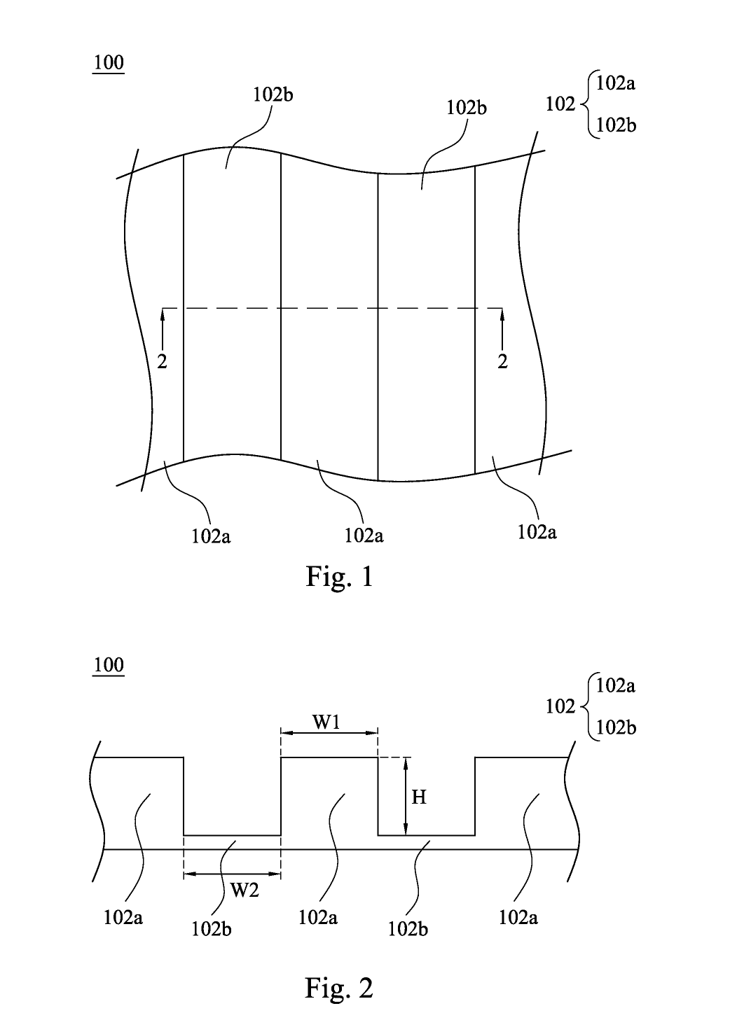

FIG. 1 is a top-view of a portion of a retardation film 100 in an intermediate stage of manufacture according to various embodiments of the present disclosure. FIG. 2 is a cross-sectional view of line 2 illustrated in FIG. 1. Referring to FIG. 1 and FIG. 2, a microstructure substrate 102 is provided. The microstructure substrate 102 has a plurality of protruding portions 102a and a plurality of recessed portions 102b alternatively arranged. As illustrated in FIG. 1 and FIG. 2, the plurality of protruding portions 102a and the plurality of recessed portions 102b are alternatively arranged to constitute the microstructure substrate 102 with a pattern of periodically ups and downs. The microstructure substrate 102 is a part of the retardation film 100, and therefore the microstructure substrate 102 is only required to be light transmittable. Corresponding to various requirements, the microstructure substrate 102 may be fully transparent, translucent, colorless or colored. Materials of the microstructure substrate 102 may be glass, cellulose triacetate (TAC), polyethylene terephthalate (PET), two acetyl cellulose, cellulose acetate butyrate, polyether sulfone, acrylic resin, polyurethane resin, polyester, polycarbonate, polysulfone, polyether, trimethyl pentene, polyether ketone, methyl acrylonitrile and the like. However, the present disclosure is not limited thereto. The pattern of periodical ups and downs in the microstructure substrate 102, which is constituted by the plurality of protruding portions 102a and the plurality of recessed portions 102b alternatively arranged, produce optical path difference of lights transmitting therein. Therefore, lights of an image transmitting through the microstructure substrate 102 with optical path difference are produced to offer right eye and left eye respectively. Accordingly, right eye and left eye respectively receive lights with optical path difference from the same image, and 3D visual effect of the image is formed. For example, lights transmitting through the plurality of protruding portions 102a are predetermined for right eye, and those through the plurality of recessed portions 102b are predetermined for left eye; and vice versa. The details of how the optical path difference between lights transmitting through the plurality of protruding portions 102a and those through the plurality of recessed portions 102b generated would be described more specifically in following paragraphs. As illustrated in FIG. 2, in various embodiments of the present disclosure, an altitude difference H between the protruding portions 102a and the recessed portions 102b is substantially 1-3 μm. Also illustrated in FIG. 2, in various embodiments of the present disclosure, a ratio of a width W1 of the protruding portion 102a and the altitude difference H is substantially 60-600. In other words, the width W1 of protruding portion 102a could be substantially 60˜1800 μm, and the width W2 of the recessed portion 102b could be substantially the same with the width W1 of protruding portion 102a. However, the present disclosure is not limited thereto. The structure of the microstructure substrate 102 could be well adjusted according various requirements. As long as the microstructure substrate 102 has the plurality of protruding portions 102a and the plurality of recessed portions 102b alternatively and periodically arranged, lights of the image transmitting through the microstructure substrate 102 with optical path difference are produced. Therefore, lights with optical path difference of the same images could be respectively received by right eye and left eye, and 3D visual effect of the image is formed.

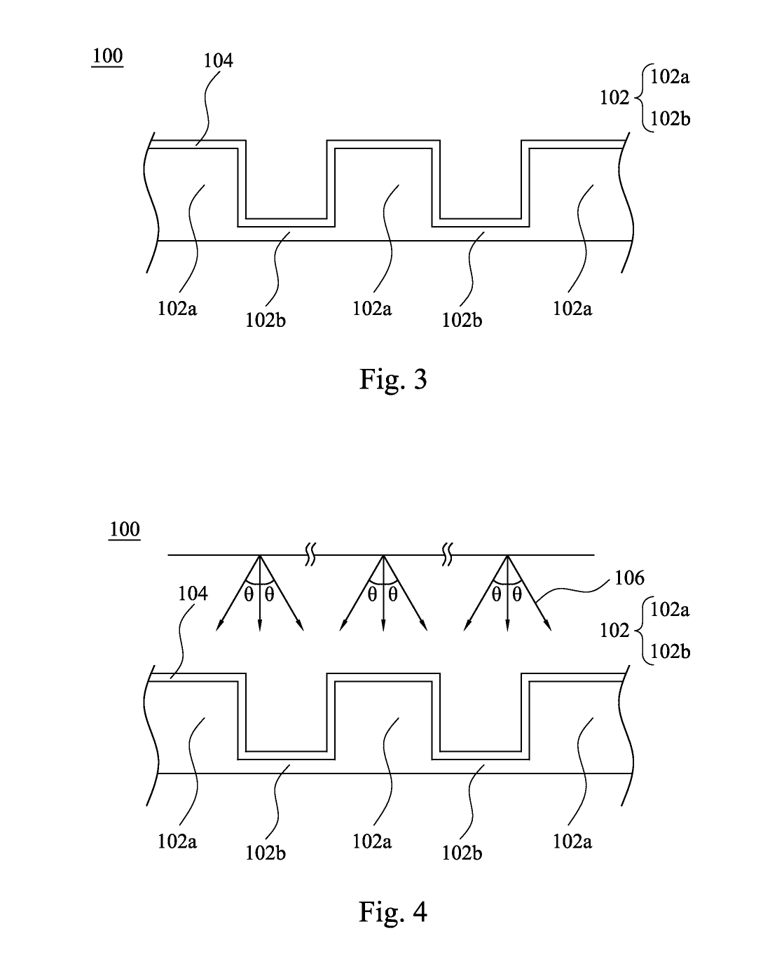

FIG. 3 is a cross-sectional view of the portion of the retardation film 100 in an intermediate stage of manufacture according to various embodiments of the present disclosure. Referring to FIG. 3, after the operation of providing the microstructure substrate 102, an optical alignment layer 104 is formed on the microstructure substrate 102. The optical alignment layer 104 is a thin film exposed by polarized UV to form anisotropic molecular alignment of the thin film, and therefore the optical alignment layer 104 has alignment characteristic. Accordingly, liquid crystals on the optical alignment layer 104 could be uniformly aligned by anisotropic molecular alignment of the optical alignment layer 104. In various embodiments of the present disclosure, the operation of forming the optical alignment layer 104 on the microstructure substrate 102 is performed by spin coating, wire bar coating, dip coating, slit coating, or roll-to roll coating a photo orientation resin on the microstructure substrate 102. The materials of photo orientation resin may be selected from materials, which can react in a photo-isomerization, a photo-crosslinking reaction, or a photo-decomposition reaction. In various embodiments of the present disclosure, the photo orientation resin includes a photo-induced cross-linking photo orientation resin, a photo-isomerization photo orientation resin, a photo-decomposition photo orientation resin, or combinations thereof. The photo-isomerization photo orientation resin could be formed by applying UV to a photosensitive polymer material so as to trigger the photo-isomerization of the photosensitive polymer material. Photosensitive parts of the photosensitive polymer material are generally unsaturated double bond, and configurations of isomers are generally classified into cis (or E) configuration and trans (or Z) configuration. Polarized UV could transform cis configuration to trans configuration of the photo-isomerization photo orientation resin. Accordingly, the optical alignment layer 104 including the photo-isomerization photo orientation resin has alignment characteristic. The photo-isomerization photo orientation resin may be azo dyes compounds. However, the present disclosure is not limited thereto. The photo-induced cross-linking photo orientation resin could be formed by applying polarized UV to a side-chain polymer material, and the photo-induced cross-linking reaction of the photosensitive polymer material is induced to form alignment characteristic. In various embodiments of the present disclosure, the photo-induced cross-linking photo orientation resin includes cinnamate, coumarin, chalcone, maleimide, quinoline, bis(benzylidene), or combinations thereof. However, the present disclosure is not limited thereto. The photo-decomposition photo orientation resin has polymers without photo-sensing groups. The polymers without photo-sensing groups are irradiated by high energy UV and chains of the polymers are decomposited anisotropically. Accordingly, the photo-decomposition photo orientation resin also has alignment characteristic. In various embodiments of the present disclosure, the photo-decomposition photo orientation resin includes polyimide, polyamide, polyester, polyurethane, or combinations thereof. However, the present disclosure is not limited thereto. As illustrated in FIG. 3, the optical alignment layer 104 is formed on the microstructure substrate 102 and covering the protruding portions 102a and the recessed portions 102b of the microstructure substrate 102. In other words, the optical alignment layer 104 is formed on surfaces and sidewalls of the protruding portions 102a and surfaces of the recessed portions 102b. The optical alignment layer 104 may be a conformal film, and therefore thickness of the optical alignment layer 104 on the surfaces and sidewalls of the protruding portions 102a and surfaces of the recessed portions 102b are substantially the same. However, the present disclosure is not limited thereto. In addition, the thickness of the optical alignment layer 104 could be in a range of 5 nm to 100 nm. The thickness of the optical alignment layer 104 could be well adjusted according to various requirements without impacting its light transmittance and alignment characteristic.

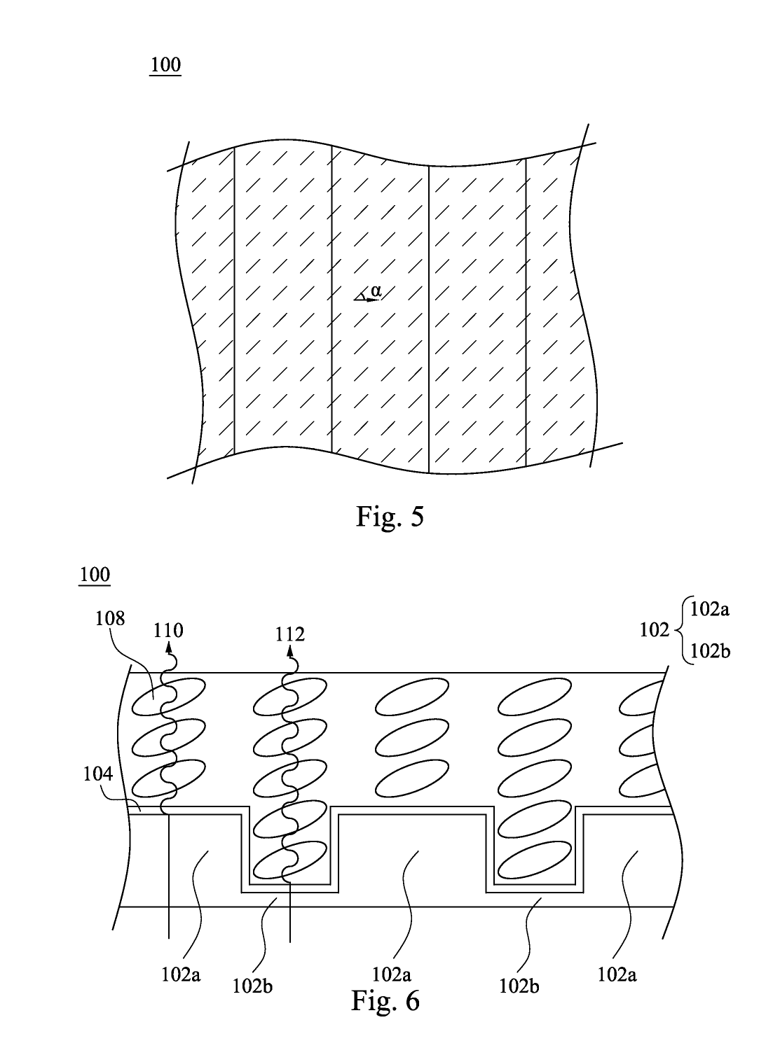

FIG. 4 is a cross-sectional view of the portion of the retardation film 100 in an intermediate stage of manufacture according to various embodiments of the present disclosure. FIG. 5 is a top-view of the retardation film 100 after being applied to a polarized ultraviolet (UV). Referring to FIG. 4, after the operation of forming the optical alignment layer 104 on the microstructure substrate 102, a polarized UV 106 is applied to the optical alignment layer 104 above the microstructure substrate 102. The optical alignment layer 104 is applied to the polarized UV 106 to become a thin film having alignment characteristic. It should be noticed that the polarized UV 160 is applied in a diffusion angle θ from normal vector of the microstructure substrate 102 such that the optical alignment layer 104 forms a uniform alignment angle α as illustrated in FIG. 5. The diffusion angle θ is substantially 20°-60°. To be more specific, after the operation of forming the optical alignment layer 104 on the surfaces and sidewalls of the protruding portions 102a and surfaces of the recessed portions 102b of the microstructure substrate 102, the polarized UV 106 is applied in the diffusion angle θ to uniformly radiate every part of the optical alignment layer 104 (including parts on surfaces of the protruding portions 102a and the recessed portions 102b, and parts on sidewalls of the protruding portions 102a). Therefore, every part of the optical alignment layer 104 could be uniformly radiated to perform aforementioned chemical reactions. Accordingly, as illustrated in FIG. 5, a uniform alignment angle α of the optical alignment layer 104 is formed. Various ways may be applied to produce the polarized UV 106 having the diffusion angle θ. In various embodiments of the present disclosure, the polarized UV is applied by combining an UV surface light source with a concave lens or a diffuser plate. Besides, a nonparallel polarized UV light source could also be applied. However, the present disclosure is not limited thereto. On the other hand, the alignment angle α of the optical alignment layer 104 may be 0-180°. The alignment angle α of the optical alignment layer 104 could be determined by liquid crystal materials combined thereto and requirements on overall displaying qualities. In various embodiments of the present disclosure, the alignment angle α is substantially 45°. In addition, a radiation dose of the polarized UV 106 could be well adjusted according to various requirements to fully form a uniform alignment angle α in each parts of the optical alignment layer 104. In various embodiments of the present disclosure, the operation of applying the polarized UV to the optical alignment layer above the microstructure substrate is performed in the radiation dose substantially 5-180 mJ/cm2. It should be noticed that each part of the optical alignment layer 104 (including parts on surfaces of the protruding portions 102a and the recessed portions 102b, and parts on sidewalls of the protruding portions 102a) on the microstructure substrate 102 could be fully reacted to form the uniform alignment angle α by applying the polarized UV 106 with the diffusion angle θ greater than 20 o according to various embodiments of the present disclosure.

FIG. 6 is a cross-sectional view of the portion of the retardation film 100 in an intermediate stage of manufacture according to various embodiments of the present disclosure. Referring to FIG. 6, after the operation of applying the polarized UV 106 to the optical alignment layer 104 above the microstructure substrate 102, a liquid crystal layer 108 is formed on the optical alignment layer 104. As illustrated in FIG. 6, liquid crystal molecules of the liquid crystal layer 108 are aligned by alignment characteristic of the optical alignment layer 104. When lights of the image enter from bottom side of the retardation film 100 and transmit it, lights 110 transmit the liquid crystal layer 108 above the protruding portions 102a have different impact from lights 112 transmit the liquid crystal layer 108 above the recessed portions 102b. Therefore, the optical path difference between lights 110 transmitting through the plurality of protruding portions 102a and lights 112 transmitting through the plurality of recessed portions 102b are produced. The optical path difference between lights 110 and 112 may be ½λ. However, the present disclosure is not limited thereto. Accordingly, lights 110 and 112 from the same image are respectively offer right eye and left eye, and 3D visual effects could be obtained.

As aforementioned, the methods of manufacturing the retardation film according various embodiments of the present disclosure are substantially different from those conventional methods. One of the differences between the present disclosure and those conventional methods is that an uniform alignment angle α in each parts of the optical alignment layer 104 is formed. Since the microstructure substrate 102 has the plurality of protruding portions 102a and the plurality of recessed portions 102b alternatively arranged, the thickness of the liquid crystal layer 108 above the protruding portions 102a is different from that above the recessed portions 102b. Therefore, lights 110 transmit the liquid crystal layer 108 above the protruding portions 102a have different impact from lights 112 transmit the liquid crystal layer 108 above the recessed portions 102b, and the optical path difference between lights 110 transmitting through the plurality of protruding portions 102a and lights 112 transmitting through the plurality of recessed portions 102b are produced, and 3D visual effects is obtained. Accordingly, only one step for forming the alignment characteristic of the retardation film is required according to various embodiments of the present disclosure. Not only complicated manufacturing processes are avoided, but also the yield is significantly improved by simplified manufacturing processes.

On the other hand, under the premise of no light leakage issue of the retardation film 100, the polarized UV 106 with the diffusion angle θ is also required to form the uniform alignment angle α in each parts of the optical alignment layer 104. Consequently, a good quality of 3D visual image could be obtained. The following examples and comparative examples verify the results of the experiment of the present disclosure:

First, the microstructure substrate 102 as illustrated in FIG. 1 and FIG. 2 is fabricated by stamping UV glue with a mold, then exposing and curing the stamped UV glue in UV light.

As illustrated in FIG. 3, the optical alignment layer 104 is formed on the microstructure substrate 102. The optical alignment layer 104 is formed in the following steps. Methyl ethyl ketone and cyclopentanone are mixed in weight ratio 1:1 so as a mixed solvent 3.5 g is formed. 0.5 g of a photo orientation resin (Switzerland Rolic, model ROP103, cinnamic acid ester, solid content 10%) is added into the mixed solvent 3.5 g. Therefore, the solid content of the photo orientation resin in the mixed solution 4 g is diluted to 1.25%. The photo orientation resin in the mixed solution 4 g is coated on the microstructure substrate 102 by spin coating (3,000 rpm, 40 seconds). The microstructure substrate 102 coated with aforementioned photo orientation resin in the mixed solution 4 g is placed into an oven for 2 minutes to remove solvents. The temperature of the oven is set to 100° C. The microstructure substrate 102 coated with aforementioned photo orientation resin is removed from the oven and cooled down to room temperature, so as the optical alignment layer 104 is formed on microstructure substrate 102.

As illustrated in FIG. 4 and FIG. 5, the polarized UV 106 is applied to the optical alignment layer 104 above the microstructure substrate 102. The alignment angle α of the polarized UV 106 is substantially 45 o, and various diffusion angles θ (θ are substantially 2°, 8°, 15°, 22°, 30°, and 60°) of the polarized UV 106 are respectively applied to the optical alignment layer 104 on the microstructure substrate 102. Therefore, the photo orientation resin in the optical alignment layer 104 reacts and the alignment characteristic of the optical alignment layer 104 is formed. Accordingly, the comparative examples 1-2 and Examples 1-4 of the retardation films are respectively fabricated.

As illustrated in FIG. 6, the liquid crystal layers 108 are respectively fabricated on the comparative examples 1-2 and examples 1-4 of the retardation films. The liquid crystal layers 108 are formed by adding 2 g of liquid crystal solid (birefringence difference Δn is 0.14) to 8 g of cyclopentanone to obtain a liquid crystal coating solution with solid content 20%. The liquid crystal coating solution is respectively coated on aforementioned comparative examples 1-2 and examples 1-4 of the retardation films (fabricated in various diffusion angles θ2°, 8°, 15°, 22°, 30°, and 60°) by spin coating (1,000 rpm, 20 seconds). The retardation films coated with the liquid crystal coating solution are placed into an oven for 5 minutes to remove solvent. The temperature of the oven is set to 60° C. The comparative examples 1-2 and Examples 1-4 of the retardation films coated with aforementioned the liquid crystal coating solution are removed from the oven and cooled down to room temperature. Finally, another UV light (with a radiation dose 120 mJ/cm²) is applied to each of the liquid crystal layers 108 respectively formed on comparative examples 1-2 and examples 1-4 of the retardation films to cure and form the liquid crystal layers 108 on comparative examples 1-2 and Examples 1-4 of the retardation films.

The experiment data of aforementioned comparative examples 1-2 and Examples 1-4 of the retardation films are summarized as the table below:

| | diffusion | |
|---|---|---|
| | angle θ | quality of display |
| Example 1 | 15° | normal with slight light leakage |
| Example 2 | 22° | without light leakage |
| Example 3 | 30° | without light leakage |
| Example 4 | 60° | without light leakage |
| comparative example 1 | 8° | with obvious light leakage |
| comparative example 2 | 2° | with obvious light leakage |

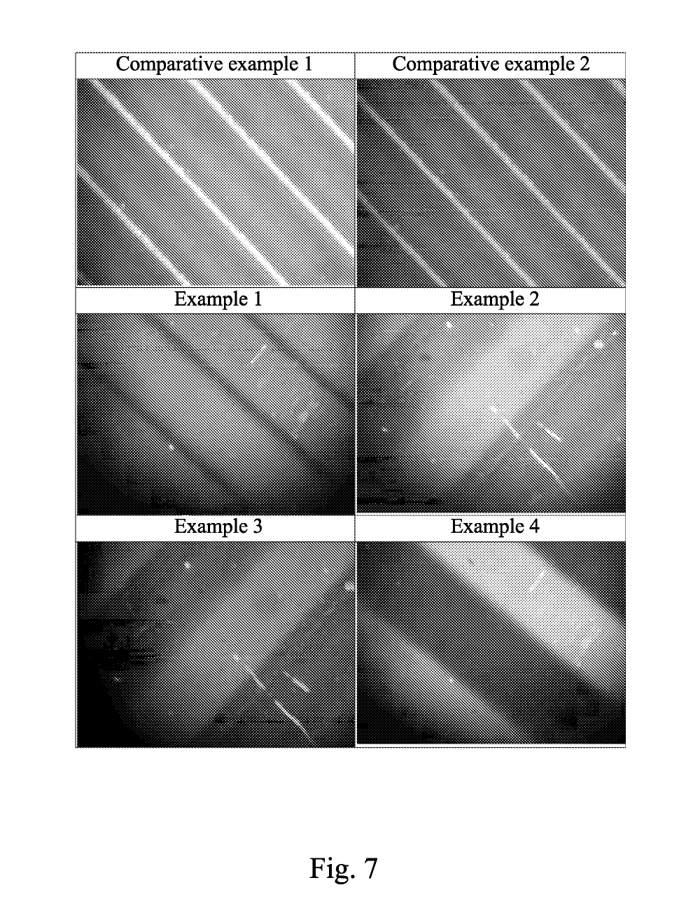

FIG. 7 is the collection of display images of comparative examples 1-2 and examples 1-4 of the retardation films. As shown in FIG. 7, when the diffusion angle θ of the polarized UV 106 is smaller than 10° (as comparative example 1-2), obvious light leakage issues are observed around boundaries between the protruding portions 102a and recessed portions 102b. The reason is that smaller diffusion angle θ of the polarized UV 106 would not be able to offer enough radiation to the optical alignment layer 104 on sidewalls of the protruding portions 102a and form effective alignment characteristic. Therefore, liquid crystals of the liquid crystal layer 108 corresponding to the boundaries between the protruding portions 102a and recessed portions 102b would be randomly aligned and obvious light leakage would be observed. In contrast, when the diffusion angle θ is increased to about 10°-20° (as Example 1), the optical alignment layer 104 on sidewalls of the protruding portions 102a forms partial alignment due to receive more radiation. Therefore, the issue of obvious light leakage is improved to slight light leakage. As the diffusion angle θ of the polarized UV 106 is increased to greater than 20° (As Examples 2-4), each part of the optical alignment layer 104 (including surfaces of the protruding portions 102a and recessed portions 102b, and sidewalls of the protruding portions 102a) could be fully radiated and form uniform alignment angle. Therefore, liquid crystals of the liquid crystal layer 108 corresponding to the boundaries between the protruding portions 102a and recessed portions 102b would be aligned well and light leakage would not be observed.

It should be noticed that the methods of manufacturing a retardation film according various embodiments of the present disclosure apply the polarized UV with the diffusion angle to produce the uniform alignment angle of the optical alignment layer. Therefore, the alignment angle of the optical alignment layer is completed in a single step. Accordingly, complicated manufacturing processes of manufacturing a retardation film are avoided, and the yield of manufacturing a retardation film is significantly improved by simplified manufacturing processes.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method of manufacturing a retardation film, comprising:
providing a microstructure substrate, the microstructure substrate having a plurality of protruding portions and a plurality of recessed portions alternatively arranged;
forming an optical alignment layer on the microstructure substrate; and
applying a polarized ultraviolet (UV) to the optical alignment layer above the microstructure substrate,
wherein the polarized UV is applied in a diffusion angle from normal vector of the microstructure substrate such that the optical alignment layer forms a uniform alignment angle, and the diffusion angle is substantially 20°-60°.

2. The method of claim 1, wherein the polarized UV is applied by combining an UV surface light source with a concave lens or a diffuser plate.

3. The method of claim 1, wherein the operation of forming the optical alignment layer on the microstructure substrate is performed by spin coating, wire bar coating, dip coating, slit coating, or roll-to roll coating a photo orientation resin on the microstructure substrate.

4. The method of claim 3, wherein the photo orientation resin comprises a photo-induced cross-linking photo orientation resin, a photo-isomerization photo orientation resin, a photo-decomposition photo orientation resin, or combinations thereof.

5. The method of claim 4, wherein the photo-induced cross-linking photo orientation resin comprises cinnamate, coumarin, chalcone, maleimide, quinoline, bis(benzylidene), or combinations thereof.

6. The method of claim 1, wherein the operation of applying the polarized UV to the optical alignment layer above the microstructure substrate is performed in a radiation dose substantially 5-180 mJ/cm².

7. The method of claim 1, wherein an altitude difference between the protruding portions and the recessed portions is substantially 1-3 μm.

8. The method of claim 7, wherein a ratio of a width of the protruding portion and the altitude difference is substantially 60-600.

9. The method of claim 1, further comprising:
forming a liquid crystal layer on the optical alignment layer.
